(19) United States
(12) Patent Application Publication
(10) Pub. No.: US 2004/0123665 A1
(43) Pub. Date: Jul. 1, 2004

(54) Nondestructive detection of reinforcing member degradation

(76) Inventors: David W. Blodgett, Ellicott City, MD (US); George L Vojtech, Centreville, MD (US)

Correspondence Address: Office of the Patent Counsel, The John Hopkins University, Applied Physics Laboratory, 11100 John Hopkin Road, Laurel, MD, 20723-6099, US

(21) Appl. No.: 10/257,712

(22) PCT Filed: Apr. 11, 2001
(86) PCT No.: PCT/US01/11637

(51) Int. Cl. G01H 13/00; G01M 7/02; G01H 1/14; G01H 9/00; G01H 15/00

(52) U.S. Cl. 73/579; 73/582; 73/662; 73/664; 702/34; 73/594

(57) ABSTRACT

A nondestructive method of and apparatus for detecting degradation of reinforcing members embedded within a structure is disclosed. Degradation can arise from many sources, such as corrosion, fracture, cracking, fatigue, chemical reaction, etc. The device includes an inducing instrument(210) to induce a vibration of the reinforcing members (110)and a measuring device (220) to detect the vibration of the reinforcing members. The measurement is analyzed to detect the presence of reinforcing member degradation or reinforcing member-to-concrete bonding. The device may include a controller (230) to enhance the detection. The device may also include an amplifier (240) to further increase the energy in the waves imparted to the structure and the acoustic waves detected by the measuring instrument.(220)

### CROSS REFERENCE TO RELATED APPLICATIONS

This application claims the benefit of U.S. Provisional Application No. 60/197,079, filed Apr. 13, 2000.

### BACKGROUND OF THE INVENTION

1. Field of the Invention

This invention relates to a method of and apparatus for detecting the degradation of a reinforcing member. More specifically, this invention relates to nondestructive detection of degradation of a reinforcing member embedded within a structure.

2. Description of the Related Art

Concrete is an artificial stone made from a mixture of water, aggregate (such as sand and gravel), and a binder (such as cement). Because of its potential for immense strength, its initial ability to adapt to virtually any form, and its resistance to fire, concrete has become one of the most common building materials in the world.

However, like stone, concrete is strong in compression and weak in tension. Thus concrete is commonly strengthened by embedding reinforcing members (“re-bar”) within it. Concrete containing embedded strengthening members is known as “reinforced concrete.” Reinforcement allows less concrete to be used because the reinforcing member provides tensile strength.

Re-bar may take many forms, but is commonly in the form of steel reinforcing bars. Re-bar contributes tensile strength to concrete. Plain concrete does not easily withstand stresses such as wind action, earthquakes, vibrations, and other bending forces, and is therefore unsuitable in many structural applications. With reinforced concrete, the tensile strength of re-bar and the compressional strength of concrete render a member capable of sustaining many types of heavy stresses over considerable spans.

In normal reinforced concrete structures, cracking must occur to allow for the transfer of tensile stresses from the concrete to the steel. These cracks allow for the penetration of chlorides through the concrete. The penetration of chlorides has been directly linked with re-bar degradation. When re-bar degrades, it can expand to twice its initial volume, resulting in a large internal stress buildup that can lead to fracture and subsequent cracking of the concrete and catastrophic failure of the structure. Detection of re-bar degradation, prior to fracture, can significantly reduce the maintenance and repair costs of concrete structures.

Current techniques for the detection of re-bar degradation rely on either imaging the re-bar itself or the cracks surrounding the re-bar. In this situation, the imaging of buried structures in the concrete is especially challenging due to the non-homogeneous nature of concrete that can have aggregate sizes ranging from, for example, 8 to 32 mm in diameter. Three imaging techniques have been employed based upon the use of impact-echo (“IE”), ultrasonic pulse velocity (“UPV”), and ground penetrating radar (“GPR”). However, these techniques require highly trained personnel to collect the data and advanced tomography algorithms to reconstruct the buried structures.

### SUMMARY OF THE INVENTION

What is needed is an improved method and apparatus for detecting re-bar degradation.

It is an object of the present invention to provide a simple technique allowing for rapid assessment of the internal structure of-a structural member under field conditions.

It is another object of the present invention to provide a simple technique allowing for nondestructive assessment of the internal structure of a structural member under field conditions.

It is an object of the present invention to provide a simple technique allowing for rapid assessment of the internal structure of concrete under field conditions.

It is another object of the present invention to provide a simple technique allowing for nondestructive assessment of the internal structure of concrete under field conditions.

It is another object of the present invention to provide a technique for the detection of re-bar degradation that is liable by personnel possessing minimal training.

It is another object of the present invention to provide an apparatus for the detection of re-bar degradation that is usable by personnel possessing minimal training.

It is another object of the present invention to provide an apparatus for nondestructively detecting re-bar degradation using commercially available equipment.

It is another object of the present invention to provide a method and apparatus for nondestructively detecting re-bar degradation that is insensitive to external variables such as concrete moisture content, re-bar size, and concrete structure location (for example, whether in soil or water).

It is another object of the present invention to provide a method of and device for nondestructively detecting the degradation of re-bar embedded within a structure without physically contacting the re-bar or the structure.

To achieve these and other objects, the present invention provides a system that is easily realizable with current technology and insensitive to external variables. If suspect concrete is found, then a more advanced imaging technique, such as GPR, IE, UPV, or conventional plug, could be employed to confirm the problem and determine the extent of the structural degradation of the concrete.

In an exemplary embodiment of the present invention, resonance is used to detect structural member degradation. Sound is produced by the vibrations of a body and is transmitted through material media in pressure waves made up of alternate condensations (forcing of the molecules of the medium together) and rarefactions (pulling of the molecules of the medium away from one another). When a sound wave of one frequency strikes a body that will vibrate naturally at the same frequency, the vibration of the body is called sympathetic vibration. Sound produced by sympathetic vibration is called resonance.

For any real harmonic motion, various forces act to reduce the amplitude with each vibration; that is, to “damp” the motion. If these forces are small compared to the restoring force arising from the original displacement, then the object will vibrate a number of times with successively smaller amplitudes until the motion gradually dies out This is known as “damped harmonic motion.”

Degradation can arise from many sources, such as corrosion, fracture, cracking, fatigue, chemical reaction, etc. The present invention provides a nondestructive method for early detection of a degraded reinforcing member in a structure. For example, the present invention allows detection of degradation of re-bar in structures, such as concrete structures, by using resonance. This method, termed “modal analysis,” uses, for example, an audio speaker to generate vibrational resonant modes in buried re-bar in reinforced concrete structures. The buried re-bar then acts as an acoustic source, generating acoustic waves. The generated waves propagate to the surface of the concrete, where they are detected and analyzed. Thus, the present invention can generate acoustic waves in the re-bar without physically contacting the structure or the re-bar. This is beneficial since it may not always be possible to generate re-bar vibrations by contact in field conditions and since physical contact may damage the structure or re-bar being tested.

Another technique for generating vibrational resonant modes in buried re-bar is using a laser to generate acoustic waves in a concrete structure. Absorption of a short pulse laser by a material results in localized thermal expansion and subsequent generation of broadband acoustic waves. This technique allows for complete non-contact generation of the required acoustic waves that would be beneficial for characterizing hard-to-reach sections of a concrete structure.

When re-bar is initially put in place within reinforced concrete, the concrete bonds to the re-bar. Typically, the concrete structure has a different harmonic frequency than does the re-bar. Thus, the concrete is not excited by the same frequency of waves that excite the re-bar. Because the concrete is bonded to the re-bar, the concrete provides resistance to the vibration of the re-bar. That is, the concrete acts to damp the vibrating re-bar. As re-bar degrades, or the concrete surrounding the re-bar degrades, the re-bar effectively disbonds or separates from the surrounding concrete. By determining the damping effect of the concrete on the re-bar, one can determine the quality of bonding between the concrete and the re-bar. A greater vibration corresponds to a lesser degree of bonding, which corresponds to a greater degree of re-bar degradation.

Measurements were performed on several specially prepared concrete blocks with re-bar of varying degrees of simulated degradation. Results from these measurements indicated that the damping constant of the resonant mode increases with increasing level of disbond. Field measurements on an old bridge over the Patuxent River at the Howard County/Montgomery County border in Maryland confirmed these results and showed that the center frequency of the resonant mode can also be used as an indication of re-bar degradation. In an exemplary embodiment of the present invention, resonant modes above about 4 kHz were specifically linked to the presence of re-bar degradation. This suggests that a pass/no pass system could be developed that simply looks for the presence of high-frequency resonant modes in the measured frequency spectra. Additional information in the measured data allows for the determination of the degree of disbond, as well as the orientation of the disbonded re-bar.

### BRIEF DESCRIPTION OF THE DRAWINGS

The present invention is described with reference to the accompanying drawings, in which like reference characters reference like elements, and wherein:

FIG. 1 is a graphical representation of an example resonant frequency measurement of a vibrating re-bar embedded within concrete;

FIG. 2 is a graphical comparison of example resonant frequency measurements from both bonded and unbonded re-bar;

FIG. 3 is a schematic representation of a preferred embodiment of the present invention;

FIG. 4 is an enlarged view of the portion of FIG. 3 enclosed by the dashed box;

FIG. 5 is a graphical comparison of the measured frequency spectra for a first set of laboratory experiments;

FIG. 6 is an enlarged view of one of the peaks of FIG. 5;

FIG. 7 is a graphical comparison of the measured frequency spectra for a second set of laboratory experiments;

FIG. 8 is a graphical comparison of the measured frequency spectra for a third set of laboratory experiments;

FIG. 9 is an enlarged view of one of the peaks in FIG. 8;

FIG. 10 is a measurement of a first field test;

FIG. 11 is a measurement of a second field test; and

FIG. 12 is a measurement of a third field test.

### DESCRIPTION OF THE PREFERRED EMBODIMENT(S)

The purpose of the present invention is to develop a portable, non-imaging, non-destructive evaluation technique and device capable of detecting a degraded reinforcing member. The preferred embodiment of the present invention takes advantage of the acoustic resonance properties of re-bar in concrete in order to determine if significant re-bar degradation is present. The physical dimensions and elastic properties determine the resonant frequencies of the re-bar. The damping constant, Q, depends on the bonding of the re-bar to the concrete. Undegraded re-bar is expected to be well bonded to the concrete. However, as the re-bar degrades and expands, it effectively disbonds from the surrounding concrete, resulting in an increase of the damping constant Q. Thus, by devising a means to measure the damping constant Q of the re-bar, the bonding characteristics (and thereby the presence of degradation) can be determined. The two important components for a portable system are the efficient generation of resonant frequencies in the re-bar and the subsequent monitoring of its resonant frequency vibrations.

The present invention takes advantage of the modal properties of the re-bar in the concrete structure to determine if significant re-bar degradation has occurred. The fundamental resonant mode of a cylindrical rod (although reinforcing members may take various forms, a cylindrical rod will be discussed for illustrative purposes only) is given by:

$$f ( L ) = \frac{1}{2 π} \sqrt{\frac{3 {Er}^{2}}{4 {L}^{4} ( 0.24 ) ρ}} , \qquad ( 1 )$$

where E is the elastic modulus, r is the radius of the rod, L is the length of the rod, and ρ is the density. Equation 1 shows that the fundamental frequency is very sensitive to the radius and length of the re-bar. However, although not shown in this equation, the resonant frequency also depends on the medium surrounding the rod. Specifically, the resonant frequency of the rod is found to decrease as the viscosity of the medium surrounding the medium increases. Therefore, if one knew the exact length and radius of the rod, any change in the resonant frequency could be attributed to a change in the viscosity of the surrounding medium. As re-bar degrades it effectively disbonds or separates from the surrounding concrete. This corresponds to the viscosity changing from that of concrete to that of air, which is a sizable difference.

However, since the physical dimensions of buried re-bar are commonly not known, resonant frequency shifts alone would not be good indicators of re-bar integrity. Thus, it is desirable to use an alternate method of analysis when the characteristics of the re-bar are not known.

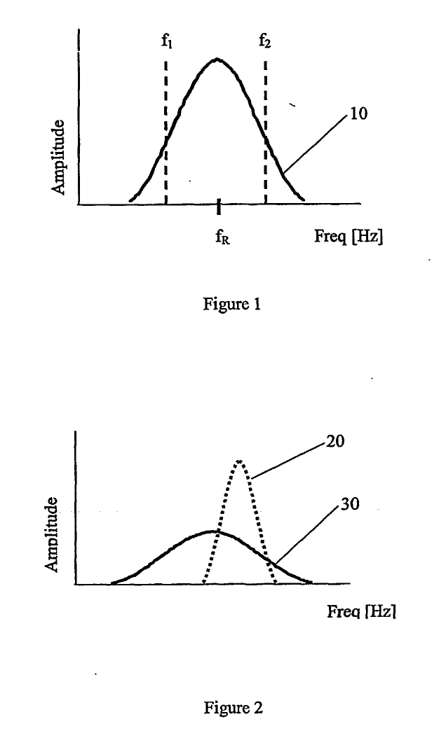

A measurement of damping can be performed on the measured re-bar response alone. This method is referred to as “modal analysis.” FIG. 1 is a graphical representation of an example resonant frequency measurement of a vibrating re-bar embedded within concrete. The horizontal axis is a measure of frequency and the vertical axis is a measure of amplitude. A simulated measurement 10 of a re-bar vibration is shown.

In FIG. 1, it is seen that measurement 10 is centered on a resonant frequency f_{R}. The amount of damping—and therefore the amount of re-bar to concrete bonding and the amount of re-bar degradation—can be determined by calculating the damping constant Q of the measured response. The damping constant Q of the re-bar is calculated by determining the ratio of the center frequency to the width of the resonant peak at 0.707 the peak (maximum) amplitude. That is,

$$Q = \frac{{f}_{R}}{{f}_{1} - {f}_{2}} , \qquad ( 2 )$$

where f_{R} is the measured resonant frequency of the re-bar and f₁ and f₂ are the frequencies corresponding to an amplitude of 0.707 that of the peak amplitude.

FIG. 2 is a simulated graphical comparison of resonant frequency measurements from both bonded and unbonded re-bar. Similarly to FIG. 1, the horizontal axis is a measure of frequency and the vertical axis is a measure of amplitude. Measurement 20 is a typical response from unbonded re-bar, while measurement 30 is a typical response from bonded re-bar. It is seen that unbonded measurement 20 has a greater resonant frequency and narrower resonant peak than does bonded measurement 30. This is due to the damping effect of the concrete on the bonded re-bar. Since there is less damping associated with unbonded re-bar than with bonded re-bar, the damping constant for unbonded re-bar is greater than the damping constant for bonded re-bar. That is,

Q_{unbonded}>Q_{bonded}. (3)

The smaller the damping constant Q, the greater the damping conditions on the surface of the rod. In terms of degradation detection, one would expect a completely disbanded re-bar to have a very high Q and a well-bonded re-bar to have a very low Q. Thus, the presence of re-bar degradation can be detected by calculating the damping constant Q of the measured vibration response from the re-bar.

The presence of re-bar degradation can also be determined by looking at the center frequencies of the detected resonant modes. Due to the size and mass of typical concrete structures, one would not expect to detect resonant modes above a few kilohertz. Any resonant modes above this threshold frequency could be attributed to disbonded (degraded) re-bar.

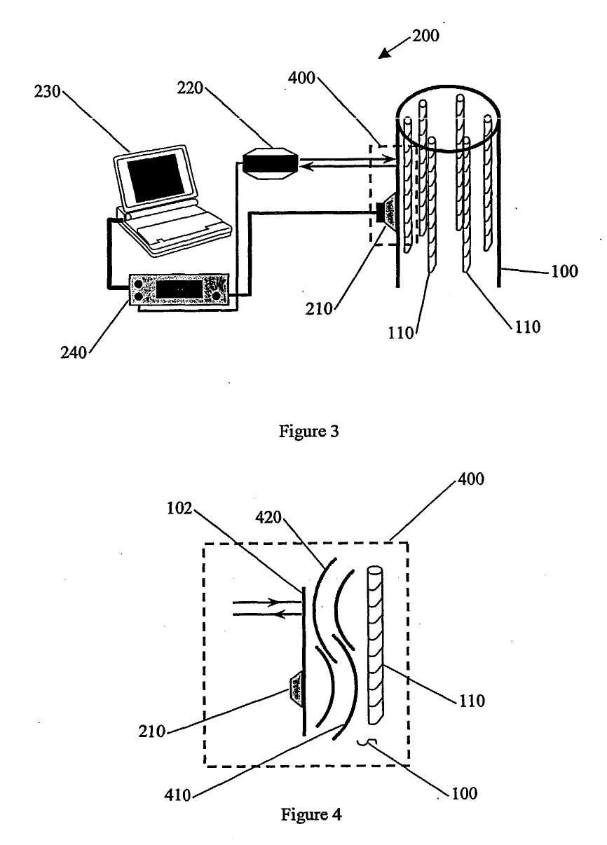

Modal analysis experiments were performed in both laboratory and field settings. FIG. 3 is a schematic representation of a preferred embodiment of a measuring device 200. A structure 100 containing re-bar 110 is shown in the form of a piling. It should be understood that the method and device of the present invention may be used on a structure of any form. Measuring device 200 is positioned proximate structure 100 in order to determine the presence of re-bar 110 degradation.

Device 200 comprises a vibration inducing instrument 210 and a measuring instrument 220. Vibration inducing instrument 210 may take various forms, such as a speaker or a laser. Inducing instrument 210 is used to generate acoustic waves within structure 100. Inducing instrument 210 should be positioned adjacent structure 100, and preferably is coupled directly to structure 100 by, for example, clamping. Measuring instrument 220 is used to detect the induced vibrations of the structure 100 and re-bar 110. Measuring instrument 220 is preferably positioned adjacent structure 100. Measuring instrument 220 detects the character (frequency, amplitude, etc.) of the vibrations induced by inducing instrument 210. The measurements can then be analyzed to determine the presence of re-bar degradation. A preferred form of measuring instrument 220 is a laser vibrometer. A laser vibrometer is compact and easy to use, and can measure the vibration frequency and amplitude of any surface from a relatively large distance away from the surface. Additionally, an accelerometer—or any other surface vibration sensing tool—may be used as measuring instrument 220. Measuring instrument 220 may include a display for displaying the measurements to allow the user to analyze the measurements to determine the presence of re-bar degradation. A separate display may also be provided.

FIG. 4 is an enlarged view of the portion of FIG. 3 enclosed by the dashed box 400. Inducing instrument 210 emits vibration inducing waves 410. Waves 410 propagate through structure 100 and impact re-bar 110, inducing re-bar 110 to vibrate. The vibrating re-bar 110 produces acoustic waves 420. Waves 420 propagate through structure 100. Measuring instrument 220 detects waves 420 at a surface 102 of structure 100. These measurements are then analyzed to detect the presence of re-bar 110 degradation. Metallic tape may be coupled to surface 102 to enhance readability of the vibrations by measuring device 220. Other enhancers, such as a small piece of aluminum sheet coupled to the concrete structure, may also be used. Enhancers are not necessary if measuring instrument 220 is of sufficient strength.

Device 200 may also comprise a controller 230. A preferred form of controller 230 is a computer. Use of controller 230 is beneficial because it can help ensure the desired frequencies are generated accurately by using a feedback loop in known fashion to control the energy imparted to the structure. Controller 230 can also help ensure efficient generation of the resonant modes in the re-bar by ramping the output of inducing instrument 210 over a range of outputs while simultaneously measuring the responses via measuring instrument 220. Additionally, controller 230 allows multiple readings to be taken at each frequency. An amplifier 240 may be used to increase the energy in the waves 410 imparted to structure 100 and the waves 420 detected by measuring instrument 220.

Preferably, controller 230 employs a software program that allows the user flexibility in the control of device 200. It is desirable that the user be able to specify the start and stop parameters, specify the number of samples obtained at each measurement step, specify the acquisition time, specify the measurement step interval, record the magnitude and phase of the measured signal, and save the results in a file for later processing. A preferred commercially available software program is LabVIEW™, which is commercially available from National Instruments™.

FIG. 13 is a flowchart of a preferred analysis process 1300. In a preferred embodiment, process 1300 is automated by a software program. Process 1300 begins at step 1310 by prompting the user to input the desired parameters for the measurement. Such parameters may include, among others, the start and stop limits, the number of samples obtained at each step, the acquisition time, and the step interval. The parameters are received from the user at step 1320. After the parameters are received from the user, a measurement process is calculated at step 1330. The calculated measurement is then performed and data collected at step 1340. This acquired data is then stored at step 1350. Storing the data allows the user to perform subsequent analysis of the data. The data is analyzed at step 1360. Process 1300 preferably includes calculating the percentage of re-bar degradation at step 1370. These results are then displayed to the user at step 1380. In a preferred embodiment, the percentage of re-bar degradation is displayed at step 1380.

The highest resolution frequency spectra are obviously obtained by making the frequency step of the waves 410 imparted by inducing instrument 210 as small as possible. The signal to noise ratio (“SNR”) of the measurement can also be improved by averaging multiple readings at each step. Generally, there is a linear dependence between the data acquisition time and the number of samples at each data point. In contrast, there is an inverse relation between the data acquisition time and the step size. Ultimately, it is the quality of the data being acquired that will determine what settings are used. In a preferred embodiment, inducing instrument 210 was a speaker and a frequency step size of 1 Hz was used with 10 samples per frequency step. These parameters provided an acceptable SNR in both laboratory and field experiments. These parameters are provided as examples only and do not limit the applicability of the present invention to other parameters.

Initial laboratory tests of the system were conducted on specially prepared concrete blocks embedded with re-bar. The concrete blocks were fabricated from standard construction grade concrete containing three parts gravel, two parts sand, and one part port 1 and cement. Each block measured 12 inches across, 18 inches high, and 5 inches deep. The first re-bar was placed 3 inches from the top of the concrete block and the remaining two re-bars at 6 inch intervals. All of the re-bar was positioned 3 inches from the front face of the concrete block. To simulate varying degrees of disbond, the re-bar was wrapped to varying degrees with a thin sheet of foam.

A first set of laboratory experiments was conducted on a concrete block containing a perfectly bonded, half bonded, and completely unbonded piece of re-bar. The partially (half) disbonded re-bar had foam wrapped along the full backside of the re-bar (as opposed to only the right- or left-hand side of the re-bar). Access ports were placed in the block to provide visual inspection of the buried re-bar. These access ports allowed direct comparison of the measured re-bar resonant modes with what was detected at the surface of the concrete. For these experiments, a speaker was used as inducing instrument 210. Speaker 210 was placed on top of the concrete block as the resonant spectrum for each re-bar was measured.

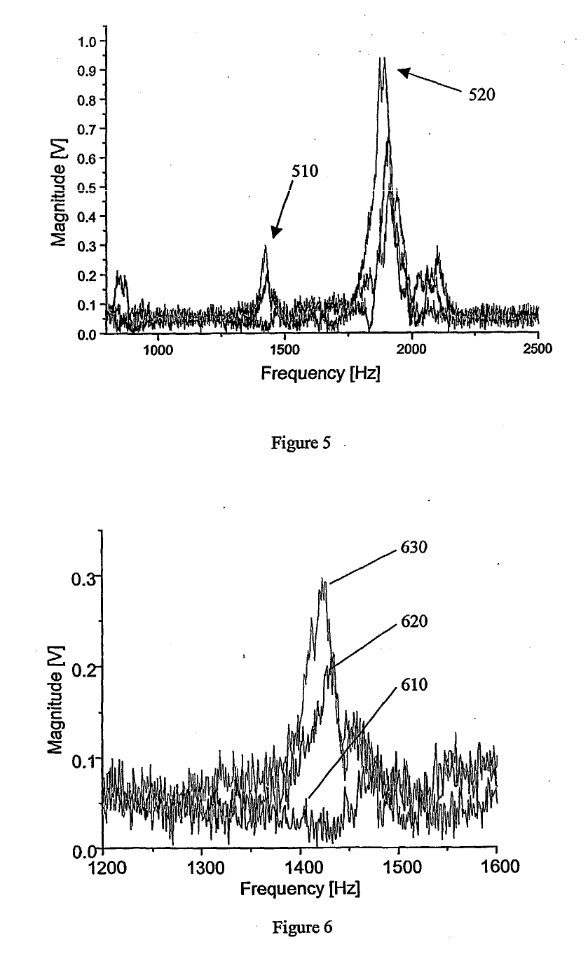

FIG. 5 is a graphical comparison of the measured frequency spectra for the first set of laboratory experiments. Two prominent peaks 510, 520 are seen. Peak 510 is at about 1400 Hz and peak 520 is at about 1900 Hz. Peak 520 is believed due to a flexural mode of the concrete itself, while peak 510 is due to the re-bar.

FIG. 6 is an enlarged view of peak 510 of FIG. 5. Measurements from all three re-bar are seen. Measurement 610 is a measurement of the completely bonded re-bar, measurement 620 is a measurement of the partially bonded re-bar, and measurement 630 is a measurement of the completely unbonded re-bar. As expected, the damping constant Q of the re-bar increases with the degree of disbond.

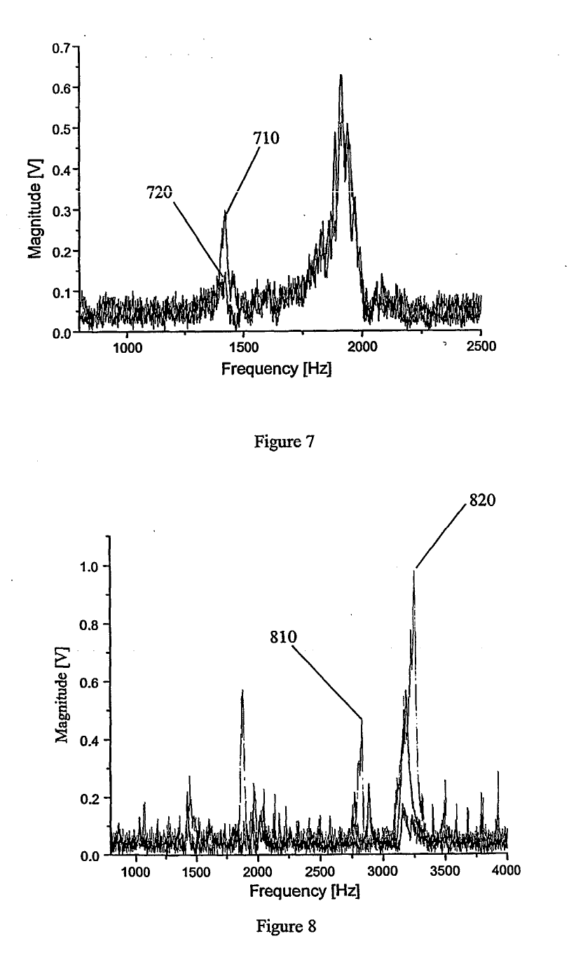

Since it will not always be possible to make measurements on the re-bar itself, a second set of laboratory experiments measured the re-bar response from the surface of the concrete block. FIG. 7 is a graphical comparison of the measured frequency spectra for the second set of laboratory experiments. Measurement 710 is a measurement of the unbonded re-bar made from the re-bar itself, and measurement 720 is a measurement of the unbonded re-bar made from the surface of the concrete structure. The resonant peaks at about 1900 Hz are substantially identical, which would be expected if they are actually due to a flexural mode of the concrete block itself. The peaks at about 1400 Hz are of more importance, particularly the second resonant peak in measurement 720. Measurement 720 was measured from the front surface of the concrete. The decrease in the amplitude of the peak is attributed to attenuation of the acoustic energy as the acoustic waves propagate from the re-bar through the structure to the surface of the concrete.

Since it will not always be possible to place the speaker on top of the concrete structure, a third set of laboratory experiments measured the re-bar response with the speaker placed behind each re-bar. The speaker was held in place with a large C-clamp and measurements were taken from the re-bar themselves. FIG. 8 is a graphical comparison of the measured frequency spectra for the third set of laboratory experiments. Two distinct sets of resonant peaks 810, 820 are seen. Peak 810 is near 2.8 kHz, and peak 820 is near 3.2 kHz.

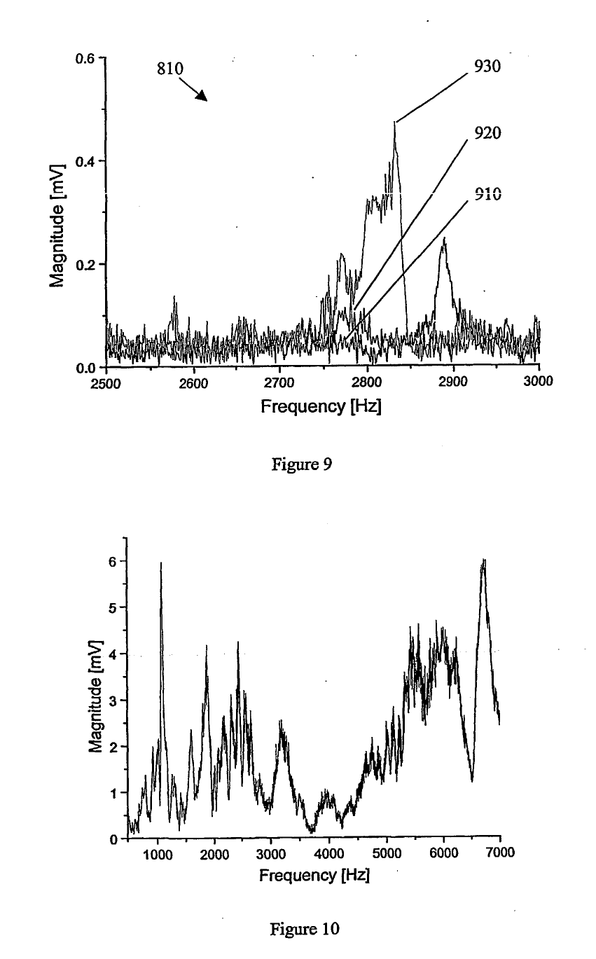

FIG. 9 is an enlarged view of peak 810, which is due to unbonded re-bar. Measurement 910 is a measurement of the completely bonded re-bar, measurement 920 is a measurement of the partially bonded re-bar, and measurement 930 is a measurement of the completely unbonded re-bar. The unbonded measurement 930 has a damping constant Q of about 66. It is difficult to estimate the damping constants Q for the partially bonded and fully bonded re-bar. However, the damping constants Q for the unbonded and partially bonded re-bar resonant mode near 3.2 kHz are more easily measured. These are about 49 and 44, respectively. These damping constants Q show the expected trend per the level of disbond, but may not have the level of sensitivity required for predicting the actual degree of disbond.

Further measurements were made for the unbonded re-bar from the re-bar itself and from the concrete surface. As before, the spectra were very similar except for the expected loss of signal due to acoustic wave attenuation.

A final set of laboratory experiments was run on another concrete block that had only one of three re-bars partially disbonded. This allowed for the effects of “cross-talk” between the re-bars to be more fully understood. For this test, one-third of the re-bars was completely wrapped in foam to simulate disbonding. Measurements were taken from nine locations in order to better understand which resonant modes were due to the concrete block and which were due to the disbonded re-bar.

The results revealed that the amplitude of the resonant mode corresponding to the disbonded re-bar decreases as the distance from the measurement location to the disbonded re-bar is increased. The results further revealed that the amplitude of the resonant mode is smaller along the longitudinal axis of the re-bar than it is perpendicular to the re-bar. This is believed to be due to the radiative field from the acoustic source (re-bar). Knowledge of the expected radiative field can therefore be used to determine the orientation of the disbanded re-bar.

To further investigate the use of the modal analysis technique for detection of re-bar degradation, a set of field experiments was conducted on a 70-year-old bridge over the Patuxent River near the Howard County/Montgomery County border in Maryland. The bridge was scheduled to be torn down, allowing the accuracy of the experimental results to be subsequently determined by destructive inspection. The experimental configuration for the field tests was generally the same as that shown in FIG. 3. All measurement locations were marked for later identification during destructive inspection.

Two pickets of the bridge were chosen for testing. The pickets were of substantially the same geometric shape, providing a good baseline measurement for comparison (by providing similar structural resonant modes). Both pickets appeared to be in good shape. However, the first picket contained a number of small surface cracks, which often indicate the presence of re-bar degradation. The second picket had minimal visible surface cracks.

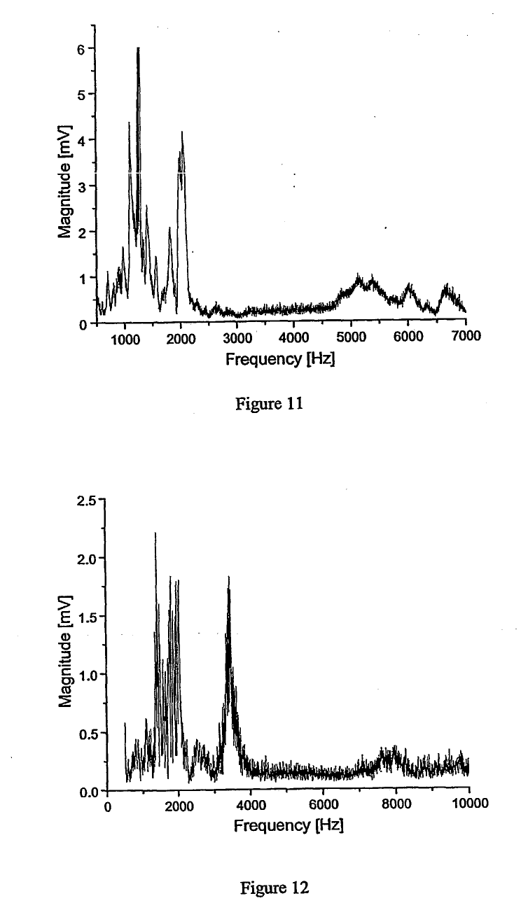

FIG. 10 is a measurement of the first picket (containing surface cracks). The presence of high frequency readings on the right-hand side of the spectrum indicates the presence of re-bar degradation. FIG. 11 is a measurement of the second picket (no surface cracks). The absence of high frequency readings indicates the absence of re-bar degradation.

It is interesting to note in FIGS. 10 and 11 the high-frequency content (greater than about 4 kHz) in each of the spectra. This high-frequency content cannot be expected from resonant modes of large concrete structures. Therefore, this high-frequency content is attributed to the presence of re-bar. The fact that the amplitude in this frequency range is greater in FIG. 10 than that in FIG. 11 indicates the presence of more re-bar degradation in FIG. 10 than in FIG. 11. Thus, re-bar degradation may be detected by measuring the amplitude of the measured resonance.

Furthermore, the presence of resonant frequencies greater than about 4 kHz itself is indicative of the presence of re-bar degradation. This threshold value may likely change dependent upon the characteristics of the particular structure being analyzed. However, it is very unlikely that any physical structure in the field will produce resonant frequencies drastically different from those of FIGS. 10 and 11. That is, the resonant frequency response from physical structures in the field will not vary significantly from those of FIGS. 10 and 11. Thus, it is safe to assume that any measured resonant frequencies exceeding about 4 kHz are due to the presence of re-bar. It may optionally be desired to analyze these high frequency readings to determine the amplitude of the measurements as an additional step in the analysis. It may optionally be desired to analyze these high frequency readings to determine the damping constant Q as an additional step in the analysis.

The pickets were subsequently removed from the bridge and destructively inspected for signs of re-bar degradation. Visual inspection confirmed the experimental results. The re-bar in the first picket showed heavy signs of degradation, while the re-bar in the second picket appeared to be in good shape.

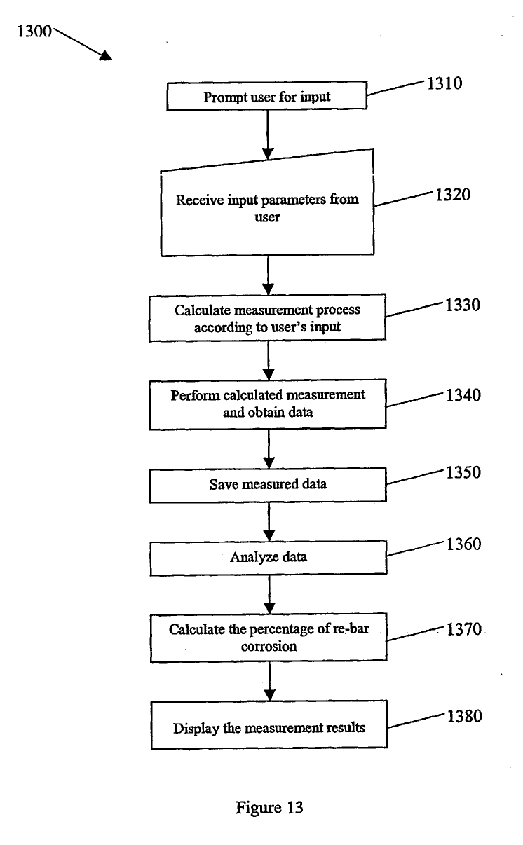

A final test was performed on the new bridge that replaced the old bridge discussed above. Obviously, no re-bar degradation would be expected for these measurements. FIG. 12 is a measurement of this field test. As with the good picket of FIG. 11, there is minimal high-frequency content in the measured spectrum. The small peak near 8 kHz may be due to either re-bar or a drainage pipe that ran inside the bridge base that emptied out just below and to the right of our measurements. The low damping constant Q of this resonant mode suggests that whatever was generating this resonant mode was well bonded to the surrounding concrete.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents.

What is claimed is:

1. A method of detecting degradation of a member within a structure, comprising:
inducing a vibration of the member;
acquiring a measurement of said vibration; and
analyzing said measurement to detect the presence of degradation of the member.

2. The method of claim 1, wherein said analyzing includes:
determining a peak frequency of said measurement; and
determining a quality of bonding between the structure and the member based on said peak frequency.

3. The method of claim 2, wherein said analyzing further includes:
determining an amplitude of said measurement; and
determining a quality of bonding between the structure and the member based on said amplitude.

4. The method of claim 3, wherein said analyzing further includes:
determining a damping characteristic of said measurement; and
determining a quality of bonding between the structure and the member based on said damping characteristic.

5. The method of claim 1, wherein said analyzing includes:
determining an amplitude of said measurement; and
determining a quality of bonding between the structure and the member based on said amplitude.

6. The method of claim 5, wherein said analyzing further includes:
determining a damping characteristic of said measurement; and
determining a quality of bonding between the structure and the member based on said damping characteristic.

7. The method of claim 1, wherein said analyzing includes:
determining a damping characteristic of said measurement; and
determining a quality of bonding between the structure and the member based on said damping characteristic.

8. The method of claim 1, wherein said analyzing includes:
determining an amount of resonant frequency shift; and
determining a quality of bonding between the structure and the member based on said amount of resonant frequency shift.

9. The method of claim 1, wherein:
said inducing includes sending a first acoustic wave through the structure to the member; and
said acquiring includes receiving a second acoustic wave through the structure from the member.

10. The method of claim 1, wherein said acquiring includes acquiring said measurement from an outer surface of the structure.

11. The method of claim 1, wherein said inducing includes inducing a vibration of the member without physically contacting the member or the structure.

12. A device for nondestructively detecting degradation of a member within a structure, comprising:
an inducing instrument located proximate the structure for inducing a vibration of the member;
a measuring instrument located proximate the structure for making a measurement of said vibration; and
a display for displaying said measurement.

13. The device of claim 12, further comprising a control system operatively coupled to said inducing instrument and said measuring instrument for controlling said inducing instrument and said measuring instrument.

14. The device of claim 13, wherein said control system includes a computer.

15. The device of claim 13, further comprising an amplifier operatively coupled to said inducing instrument and said measuring instrument.

16. The device of claim 12, further comprising an amplifier operatively coupled to said inducing instrument and said measuring instrument.

17. The device of claim 12, wherein said measuring instrument is a laser vibrometer.

18. The device of claim 12, wherein said measuring instrument is an accelerometer.

19. The device of claim 12, wherein said inducing instrument is a speaker.

20. The device of claim 12, wherein said inducing instrument is a laser.

21. A method of detecting degradation of a member within a structure, comprising:
receiving parameter input from a user;
calculating a measurement process based on said parameter input;
performing said measurement process to collect data;
analyzing said data to determine the presence of degradation of the member; and
displaying a measurement result.

22. The method of claim 21, wherein:
said analyzing includes determining a percentage of re-bar degradation; and
said displaying includes displaying said percentage.
